(19) United States
(12) Patent Application Publication
(10) Pub. No.: US 2020/0061666 A1
(43) Pub. Date: Feb. 27, 2020

(54) UV Coating Layer Hardening Device

(71) Applicant: Gusztav Horvath, Dronten (NL)

(72) Inventor: Gusztav Horvath, Dronten (NL)

(21) Appl. No.: 16/484,082

(22) PCT Filed: Jun. 6, 2017
(86) PCT No.: PCT/NL2017/050371

§ 371 Date: Aug. 6, 2019

(30) Foreign Application Priority Data
Feb. 6, 2017 (NL) 2018316
Feb. 7, 2017 (NL) 2018334

(51) Int. Cl. B05D 3/06; B05D 5/00

(52) U.S. Cl. CPC B05D 3/067; B05D 5/005

(57) ABSTRACT

The present invention relates to a UV coating layer hardening device for hardening of a coating in a repair workshop for an automobile by means of UV radiation suitable for irradiating of a coating layer to be hardened that is applied to a surface of the automobile, including: a number of bearer elements for bearing of a number of LED based UV radiation sources, optics per radiation source for spreading of the UV radiation at a predetermined manner under an irradiation angle, the number of UV radiation sources in cooperation with the respective optics per radiation source are arranged in such a manner that a predetermined area of the surface is arrangeable with an intensity or intensity per time period with a predetermined minimum and a predetermined maximum, in which the minimum provides a predetermined degree of hardening and in which the maximum does not exceed a certain threshold.

The present invention relates to a UV coating hardening layer device for hardening of a coating layer in a repair workshop for an automobile by means of UV radiation suitable for irradiating of a coating layer to be hardened that is applied to a surface of the automobile.

With the mobiles or parts thereof are treated with a coating or an assembly of coatings for the purpose of a positive appearance, such as by color or shine, in the factory in which they are manufactured. In such a production factory, it is possible to apply coatings that are hardened under high temperatures, such as in an oven. The reason for this is that in a series production, manufacturing can be performed practically continuous and installations are arranged for that with an optimal speed in which the speed is a more important parameter than the size of the installation.

However, when repairing the mobiles, such as in case of damage or aging, visual of the mobiles are partly repaired, in which case it is not possible to treat the whole car in an oven for hardening of a coating. To this end, coatings, after applying there of old a repaired vehicle, are hardened by means of direct radiation need, such as by means of an infrared lamp. Because of this, is possible to perform jobs flexibly but the drying times are much longer than with mass production of the original automobile.

The present inventor thus determined a desire to shorten the drying time such that for example the automobile can remain in the cabin between the application of several layers of coating.

Based on the determination of this desire and by coming into contact with materials for forming of a coating that can be hardened under the influence of UV radiation, the present inventor started experiments devising a device suitable for irradiating a surface of an automobile treated with material for forming of a coating in such a way that it would become possible through realize a suitably hardened coating while applying a suitable device that 2.

As a result of these experiments, the present invention provides a UV coating layer hardening device for hardening of a coating layer in a repair workshop for an automobile by means of UV radiation suitable for irradiating of a coating layer to be hardened that is applied to a surface of the automobile, comprising:
a number of bearer elements for bearing of a number of LED based UV radiation sources,
optics per radiation source for spreading of the UV radiation at a predetermined manner under a irradiation angle,
the number of UV radiation sources in cooperation with the respective optics per radiation source are arranged in such a manner that there with a predetermined area of the surface is arrangeable with an intensity or intensity per time period with a predetermined minimum and a predetermined maximum, in which the minimum provides a predetermined degree of hardening and in which the maximum does not exceed a certain threshold.

An advantage of a device according to the present invention is that over the whole surface of the auto mobile provided with coating material, a hardening of high quality is realized.

It is of importance that the quantity of absorbed radiation energy is sufficient at each part of the surface. In other words, it is prevented that parts received too little energy, and that it is prevented that parts Received too much energy, or receive relatively too much energy.

A device according to the present invention allows for drying times that are a fraction of the drying times with a heat treatment, such as ⅙ to ½ thereof. In cases in which, with a drying time of substantially-hour, it would have been sensible to move the automobile, treat a further automobile with a coating and have the automobile and the girl the treatment at another location, with the application of the present invention, it is sensible to leave the automobile at one location for all coating layers and at the same location subsequently perform the application of the coating layers with the execution of the hardening treatment.

A further advantage of the present invention is that a UV cover layer hardening device can be used in several treatment cabins for automobiles. The reason for this is that the device can be embodied with such a lightweight that it is easily transportable between two or more adjacently arranged cabins.

According to a first preferred embodiment, in a coating layer hardening device, the optics are arranged for irradiating of the UV radiation under an irradiation angle of 30-90°, preferably 40-80°, further preferably 45-75°, further preferably 50-70°, further preferably 55-65 to his, further preferably substantially 60°. Further preferably, as part of the optics, the UV radiation source are provided with a directly thereon arranged radiation source lens.

Further preferably, as part of the optics, the lens body is provided for taking and passing through of the UV radiation.

The device comprises an array of spreading elements, according to a further preferred embodiment, for towards the surface irradiated UV radiation, in which each spreading element is suitable for providing of the irradiation angle.

Further preferably, the array of spreading elements is formed in an irradiation surface of the lens body.

Further preferably, a carrier element comprises a carrier body that is formed as a profile, such as an extrusion profile.

According to a further preferred embodiment, the array of LED based UV radiation sources are arranged on a substrate, such as a circuit board.

Further preferably, the substrate is permanently coupled with a mass of the respective carrier element, preferably while applying a thermally conductive paste. Further preferably, in a carrier element the array is substantially arranged linearly.

Further preferably, the carrier element comprises a cover element that is penetrable to the UV radiation, preferably manufactured from a plastic, such as a poly methyl acrylate.

Further preferably, the device comprises a control unit for providing of a suitable electricity supply for each array of UV radiation sources.

Further preferably, the device comprises a registration unit for registry of the respective workloads of arrays of UV radiation sources.

Further preferably, in the device each carrier element or substrate part therein is provided with an identification, preferably in contact with control electronics thereof, wherein the registration is performed based on the identifications of an array of UV radiation sources, such as a serial number.

Further preferably, each carrier element fulfills a degree of predetermined watertightness and/or dust tightness, such as indicated with an IP 64, wherein further preferably connectors are comprised of connectors of the type XLR.

Further preferably, device comprises an elongated sealing member, arranged between the carrier body and the copper element, further preferably kept under bias by means of a cover plate lock in element.

With this, preferably the array of UV radiation sources in cooperation with the respective optics per radiation source are arranged for treating of the surface within a predetermined distance range, in which preferably the distance range is within the range of 20 and 60 cm, further preferably between 30 and 50 cm, further preferably within 35 and 45 cm, further preferably substantially about 40 cm.

With this, further preferably the lens body is covered by an element for inhibiting of UV radiation.

According to a further preferred embodiment, the radiation sources are arranged for radiation of UV radiation with a wavelength between 350 and 440 nm, further preferably between 370 and 430 nm, further preferably between 380 and 420 nm, further preferably between 390 and 410 nm, further preferably between 400 and 110 nm, further preferably substantially with a highest intensity around 408 nm.

the number of carrier elements is arranged at a frame, in which at least a part of the number of bearer elements is arranged in parallel.

The frame further preferably comprises at least one subframe for thereto arranging of another part of the number of carrier elements.

With this, at least single subframe is arranged movable, such as hingable relative to the frame.

A further aspect according to the present invention relates to a method for hardening of a cover layer under application of a UV cover layer hardening device suitable for irradiating by means of UV radiation of a surface of the surface of the automobile applied cover layer to be hardened, the method comprising steps for providing an automobile with a coating to be hardened and irradiating the coating to be hardened by means of the UV cover layer hardening device, preferably according to the present invention. Such method comprises advantages as indicated relating to earlier preferred embodiments.

An LED in the context of the present description irradiated slide in a wavelength as described.

Further advantages, features and details of the present invention will be further elucidated on the basis of a description of one or more embodiments with reference to the accompanying figures. Similar yet not necessarily identical parts of different preferred embodiments are indicated with the same reference numerals.

A first preferred embodiment according to the present invention relates to a UV cover layer hardening device 1. This comprises a number of carrier elements 11 carrying LED based UV radiation sources 12 for providing of a an even irradiation of a surface of an automobile. The radiation sources are also provided with optics 12. The optics are formed by a radiation source lens directly on the LED, which LED is arranged at a circuit board that is arranged directly against the profile forming the body of the respective carrier element by means of heat paste.

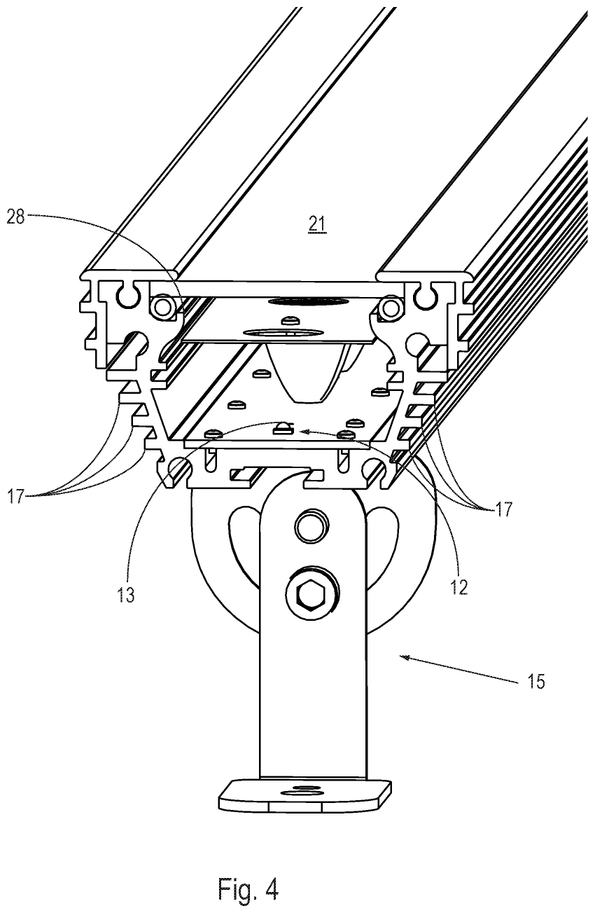

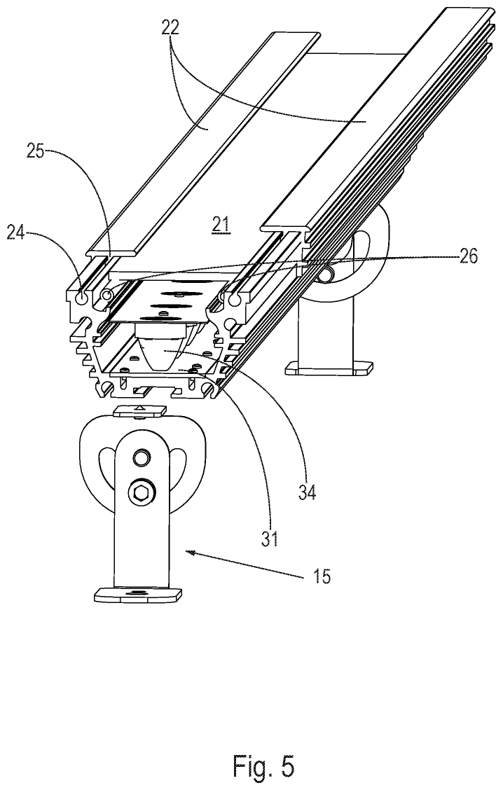

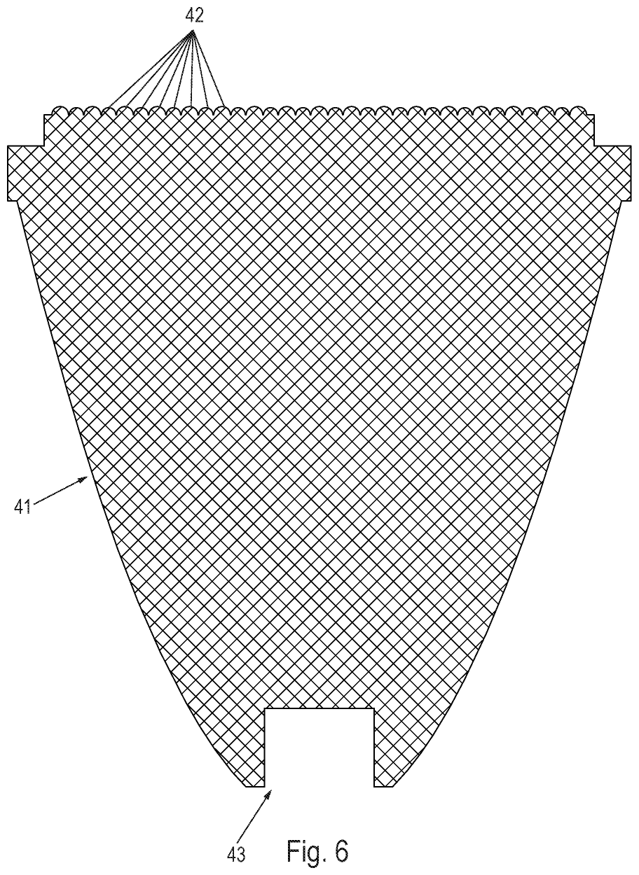

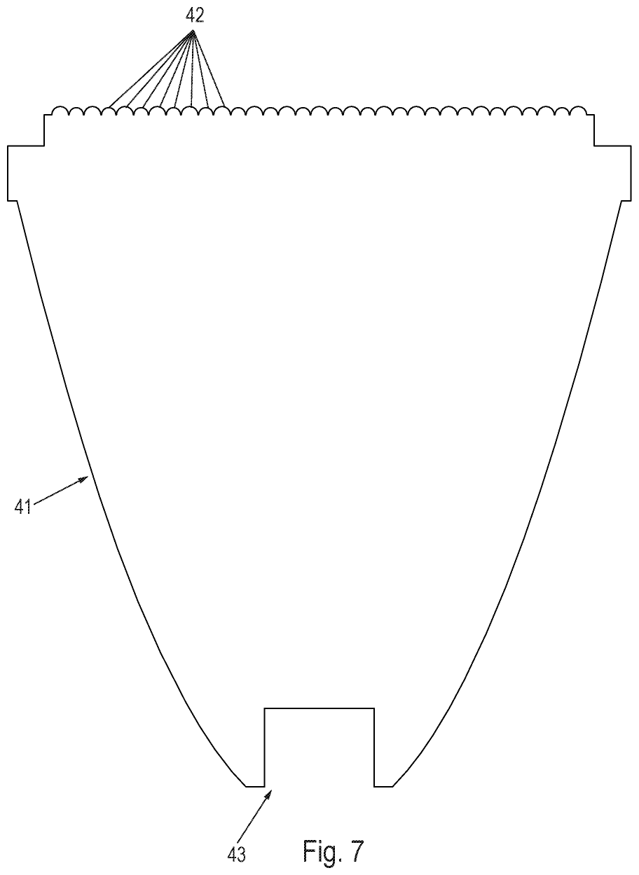

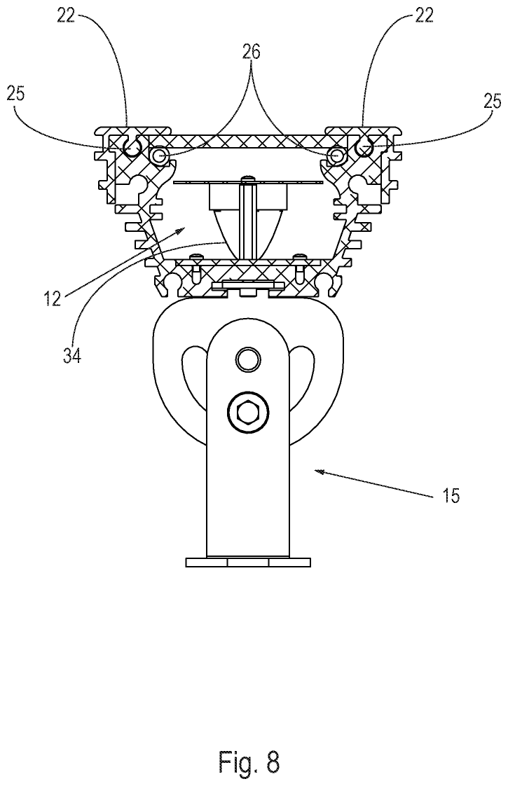

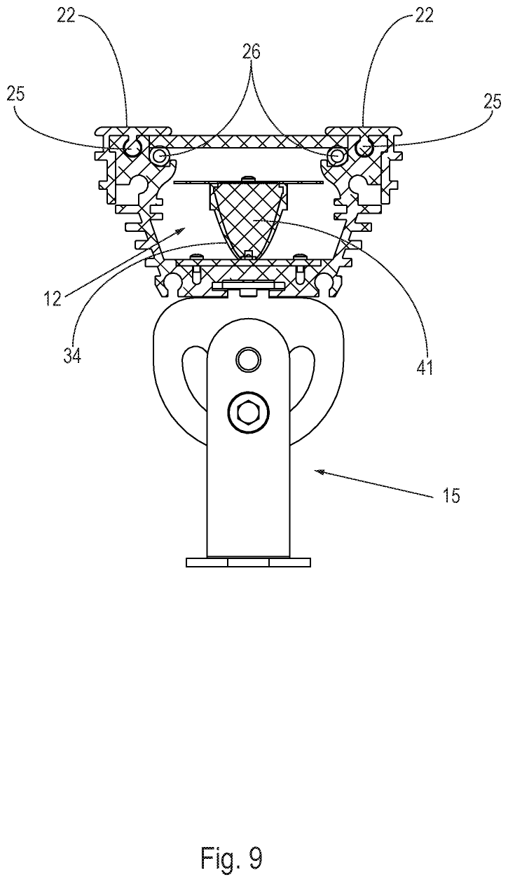

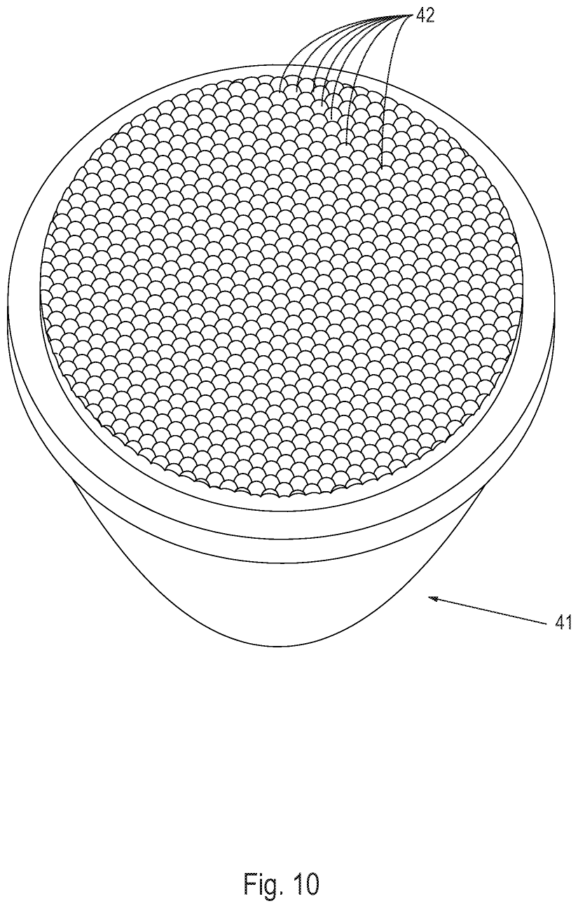

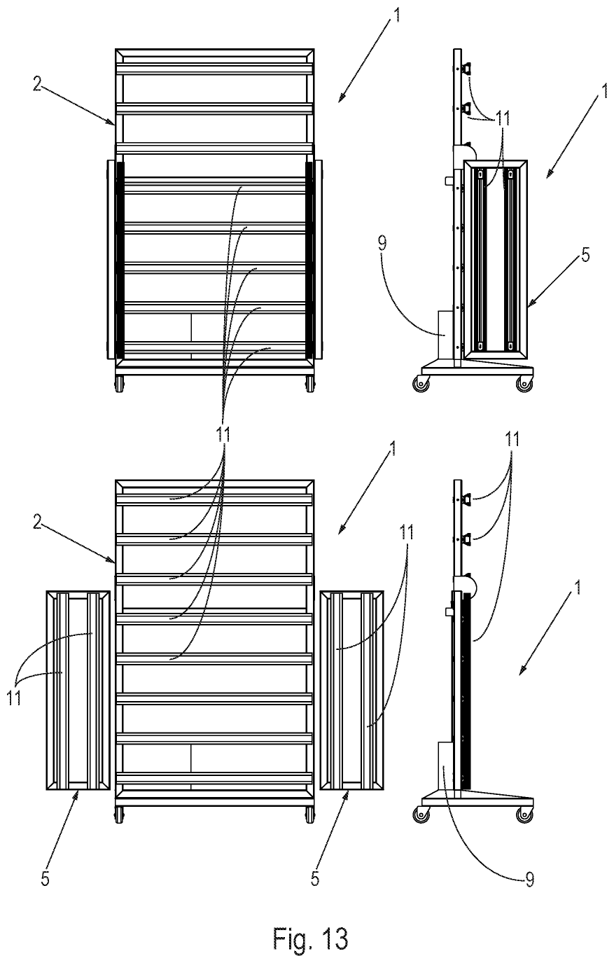

The carrier elements 11 are arranged at a frame to in a mutual substantially equal distance. By means of this arrangement, the LEDs provide an irradiation towards the surface according for example a graph of FIG. 10 and FIG. 12. Therein, it is shown how the radiation is relatively equally achieved between an intensity of substantially 323, 5 in FIG. 12.

The carrier element is built up on the basis of the profile 15 comprising cooling ribs 17 for cooling of the carrier element 11. The UV light sources 12 are arranged in a circuit board 31 that is connected to a power supply 57 that is arranged at the frame. The cooling of the circuit board with therein arranged radiation sources is furthermore optimized by applying heat paste such as comprising an in oil mixed number of silver particles.

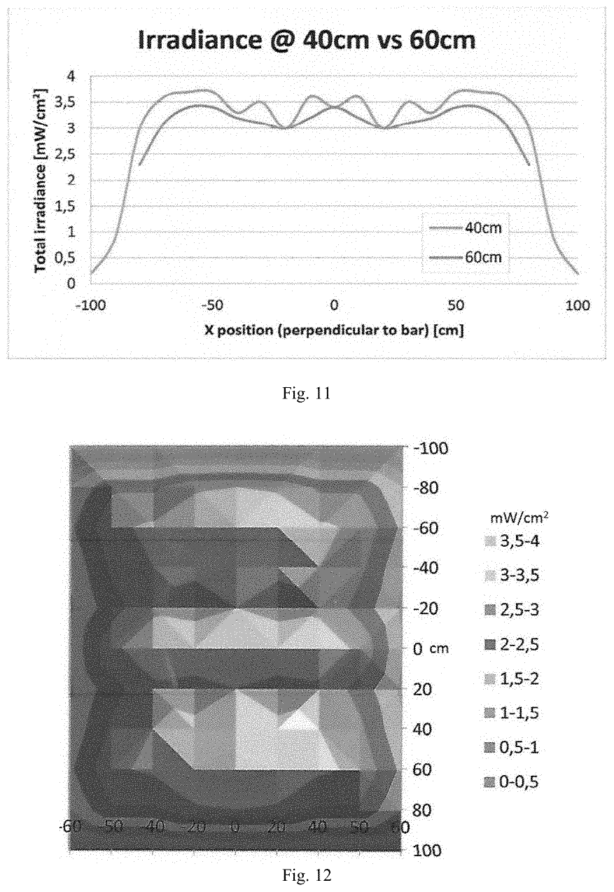

At the UV light source 12, a spherical or semi spherical lens 13 is arranged with a UV penetrable UV resistant material, such as a silicone or polymethylacrylate. Over the radiation source lens 13, a lens body 41 is arranged that is provided at the bottom side of an opening 43 for arrangement of the spherical radiation source lens 13. At the upper side of the lens 41 and array of lenses 42 is arranged in a matrix, in this example in a honeycomb structure arranged, such as is shown in FIG. 11. Each of these matrix lenses 42 is formed for providing of the predetermined period deviation angle says as preferably 60%.

The lens body 41 is surrounded by a radiation barrier body 34 4 directing of substantially the whole of the radiation in upward direction toward lenses 42. With this, it is also prevented that UV light is irradiated within the profile 15 which protects the electronics therein.

For the purpose of closing off of the profile 15, at the upper side a plate 21 is arranged that is clamps between an edge 28 of the profile and the slide in profiles 22 that are provided with an in cross-section circular sliding age for arranging in the circular slot 24. For the purpose of substantially dust and waterproof sealing, clams in rubber or plastic rope 26 is provided. This clamps the plate 21 or over the whole length report toward the slide in profiles from the edge 28.

With this, it is achieved that the profile is closed over the whole length. At the short ends of the profile, it is closed by means of caps 14 with between the caps at the profile a silicone seal.

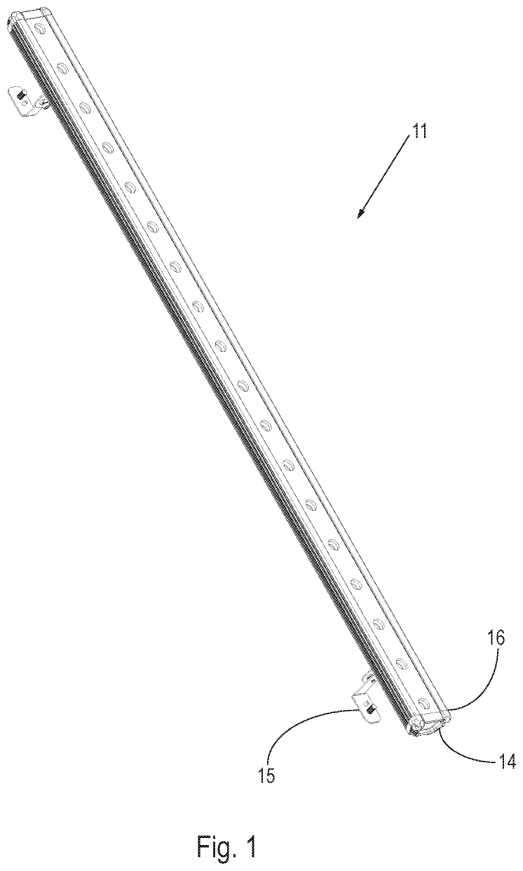

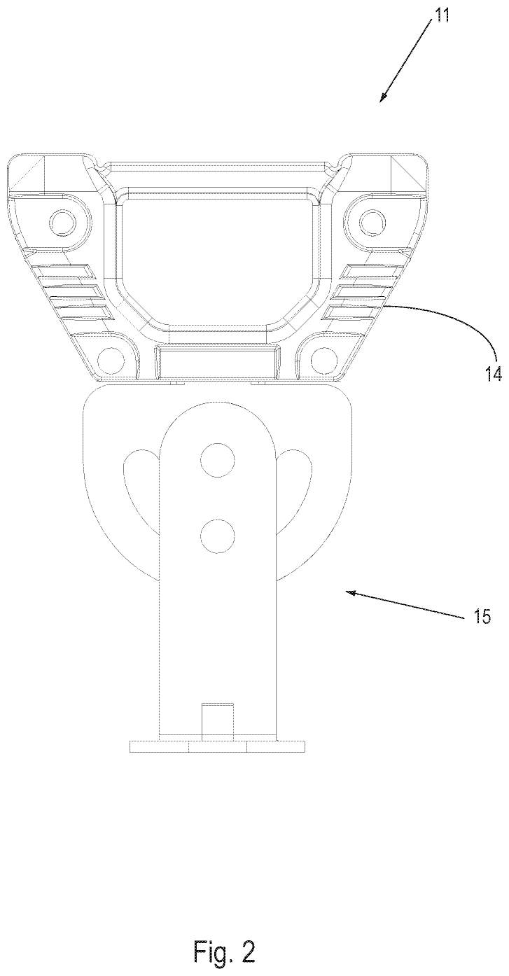

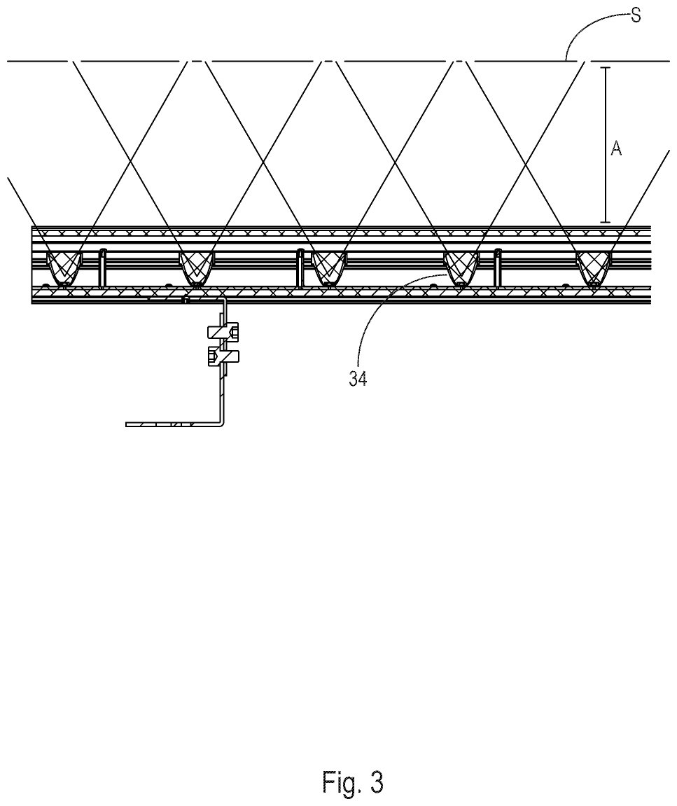

In FIG. 3, it is shown how, in side view, the radiation bundles radiated towards a surface as at the indicated preferred distance.

The frame 2 is provided with 2 wings 5 arranged at the side with which coated parts of an automobile part substantially as the preferred distance being irradiated. Depending of the type off vehicle that is irradiated, the frame is given such a shape that within the understanding of the present invention all surface can be irradiated from the preferred distance for sufficiently uniform irradiation. The present invention is described in the foregoing on the basis of several preferred embodiments. Different aspects of different embodiments can be combined, wherein all combinations which can be made by a skilled person on the basis of this document must be included. These preferred embodiments are not limitative for the scope of protection of this document. The rights sought are defined in the appended claims.

1. A UV coating layer hardening device for hardening of a coating layer in a repair workshop for an automobile by means of UV radiation suitable for irradiating of a coating layer to be hardened that is applied to a surface of the automobile, comprising:
a number of bearer elements for bearing of a number of LED based UV radiation sources,
optics per radiation source for spreading of the UV radiation at a predetermined manner under a irradiation angle,
the number of UV radiation sources in cooperation with the respective optics per radiation source are arranged in an array in such a manner that a predetermined area of the surface is arrangeable with an intensity or intensity per time period with a predetermined minimum and a predetermined maximum, in which the minimum provides a predetermined degree of hardening and in which the maximum does not exceed a predetermined threshold.

2. The UV coating layer hardening device according to claim 1, in which the optics are arranged for irradiating of the UV radiation under an irradiation angle of 30-90°, preferably 40-80°, further preferably 45-75°, further preferably 50-70°, further preferably 55-65 to his, further preferably substantially 60°.

3. The UV coating layer hardening device according to claim 1, in which as part of the optics, the UV radiation source is provided to with a directly thereon arranged radiation source lens.

4. The UV coating layer hardening device according to claim 1, in which as part of the optics, a lens body is provided for taking in and passing through of the UV radiation.

5. The UV coating layer hardening device according to claim 1 comprising an array of spreading elements for towards the surface irradiated UV radiation, in which each spreading element is suitable for providing of the irradiation angle.

6. The UV coating layer hardening device according to claim 5, in which the array of spreading elements is formed in an irradiation surface of the lens body.

7. The UV coating layer hardening device according to claim 1, in which a bearer element comprises a carrier body that is formed as a profile.

8. The UV the coating layer hardening device according to claim 1, in which the array of LED based UV radiation sources are arranged on a substrate.

9. The UV coating layer hardening device according to claim 8, in which the substrate is permanently coupled with a mass of a respective bearer element.

10. The UV coating layer hardening device according to claim 1, in which in a bearer element the array of UV radiation sources is substantially arranged linearly.

11. The UV coating layer hardening device according to claim 1, in which the bearer element comprises a cover element that is penetrable to the UV radiation, preferably manufactured from a plastic.

12. The UV cover layer hardening device according to claim 1, comprising a control unit for providing of a suitable electricity supply for each array of UV radiation sources.

13. The UV cover layer hardening device according to claim 12, comprising a registration unit for registry of the respective workloads of arrays of UV radiation sources.

14. The UV cover layer hardening device according to claim 13, in which each bearer element or substrate part therein is provided with an identification, wherein the registration is performed based on the identifications of an array of UV radiation sources.

15. The UV cover layer hardening device according to claim 1, in which the bearer element fulfills a predetermined watertightness and/or dust tightness rating.

16. The UV cover layer hardening device according to claim 1 comprising an elongated sealing member, arranged between the carrier body and the copper element.

17. The UV cover layer hardening device according to claim 1 in which the array of UV radiation sources in cooperation with the respective optics per radiation source are arranged for treating of the surface within a predetermined distance range.

18. The UV cover layer hardening device according to claim 1, in which the lens body is covered by an element for inhibiting of UV radiation.

19. The UV cover layer hardening device according to claim 1, in which the radiation sources are arranged for radiation of UV radiation with a wavelength between 350 and 440 nm.

20. The UV cover layer hardening device according to claim 1, in which the number of bearer elements is arranged at a frame, in which at least a part of the number of bearer elements is arranged in parallel.

21. The UV cover layer hardening device according to claim 20, in which the frame comprises at least one subframe for thereto arranging of another part of the number of bearer elements.

22. The UV cover layer hardening device according to claim 21, in which the at least single subframe is arranged movable.

23. A method for hardening of a cover layer under application of a UV cover layer hardening device suitable for irradiating by means of UV radiation of a surface of the surface of the automobile applied cover layer to be hardened, the method comprising steps for providing an automobile with a coating to be hardened and irradiating the coating to be hardened by means of the UV cover layer hardening device.
